(19) United States
(12) Patent Application Publication
(10) Pub. No.: US 2016/0055156 A1
(43) Pub. Date: Feb. 25, 2016

(54) DATABASE QUERY CACHING AND REUSE

(71) Applicant: International Business Machines Corporation, Armonk, NY (US)

(72) Inventors: Shuo Li, Beijing (CN); Ke Wei Wei, Beijing (CN); Xin Ying Yang, Beijing (CN); Xiang Zhou, Hangzhou (CN)

(21) Appl. No.: 14/753,123

(22) Filed: Jun. 29, 2015

(30) Foreign Application Priority Data
Aug. 22, 2014 (CN) 201410419660.3

(51) Int. Cl. G06F 17/30; G06F 12/08

(52) U.S. Cl. CPC G06F 17/3048; G06F 12/0864; G06F 2212/6032

(57) ABSTRACT

A query block may be cached, not like the traditional solution, which can only cache a query result for the query block. For example, a work file for storing a result set of a query block may be maintained after relevant query has been completed. In subsequent use, once a query for the query block is received, query may be processed quickly by directly reusing the result set. In this way, the data overheads for reducing the query processing can be significantly reduced, and the response time for shorting the query processing can be shortened. Corresponding methods and systems are described in the present disclosure.

### BACKGROUND

The present invention relates generally to the field of database, and more specifically, to a method and system for database query.

The overall performance of a database system depends on the cost and efficiency of query process of the data base to a great extent. In a query for database, query blocks are always used. For example, a user may create a view based on one or more data tables in the database and then perform a query operation on the view. A query statements for creating the view form a query block. For another example, when a query includes nested database expressions indicating sub-queries, each sub-query may be regarded as a query block.

A common technology for processing a query block is materialization. Specifically, data records involved in the query block are extracted from a corresponding data table and is saved in a work file. Such data stored in the work file are called a result set. Operations regarding the query block will be executed in a work file based result set, just like the result set is a data table in the database. In this case, the query block is called a materialized query block (hereinafter MQB).

Traditionally, after the query for the MQB is completely performed, the work file for the query block will be released. Afterwards, when receiving a query for the same query block, the materialized process has to be repeated, i.e., creating and releasing the work file again. In order to enhance query efficiency, it has been proposed to cache and reuse the entire query result of the query block. That is, if a query is exactly the same as a previous query, the query result of the previous query can be reused. However, such a traditional cache solution is only suitable for the scenario where two queries are completely identical. Different queries for the same content cannot be accelerated yet. Moreover, such solutions require storage of all the queries, which causes significant storage cost.

### SUMMARY

In general, embodiments of the present invention provide a technical solution for database query.

In one aspect, an embodiment of the present invention provides a method for query. The method comprises: obtaining a query block contained in a query for a database; and in response to the query block satisfying the predetermined caching condition, creating a cache entry for the query block, whereby the cache entry indicates a statement and a result set for the query block, and wherein the cache entry is maintained for a time period after the query is completed.

Another embodiment in this aspect provides a computer system for query. The computer system comprises: a query block obtaining unit to obtain a query block contained in a query for a database; and a cache creating unit to, in response to the query block satisfying the predetermined caching condition, create a cache entry for the query block, whereby the cache entry indicates statements and a result set for the query block, and the result set is maintained for a time period after the query is completed.

In another aspect, an embodiment of the present invention provides a method for reusing a query block. The method comprises: determining whether a query for the database has a query block, and in response to the query containing the query block, searching a matching cache entry based on a statement of the query block, whereby the matching cache entry indicates that statements and a result set of a previous query block match the query block; and in response to identifying the matching cache entry, performing the query by reusing the result set of the previous query block.

Another embodiment invention in this aspect provides a computer system for reusing a query block. The computer system comprises: a query block determining unit to determine whether a query for the database has a query block; a cache searching unit to, in response to the query containing the query block, search a matching cache entry in a query cache based on a statement of the query block, whereby the matching cache entry indicates a statement and a result set of a previous query block matching the query block; and a query performing unit to, in response to receiving the matching cache entry, perform the query by reusing the result set of the previous query block.

It would be understood through the following description that according to embodiments of the present invention, a query block per se may be cached, not like the traditional solution, which can only cache a query result for the query block. For example, a work file for storing a result set of a query block may be maintained after relevant query has been completed. In subsequent use, once a query for the query block is received, the query may be processed quickly by directly reusing the result set. In this way, the data overheads for reducing the query processing can be significantly reduced, and the response time for shorting the query processing can be shortened. Other features and advantages of the present invention will become easily comprehensible through the description infra

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 shows an exemplary computer system/server which is applicable to implement embodiments of the present invention;

FIG. 2 shows a schematic flow diagram of a method for query according to an embodiment of the present invention;

FIG. 3 shows a schematic block diagram of a cache entry for a query block according to an embodiment of the present invention;

FIG. 4 shows a schematic diagram for correlating a cache entry of a query block with a relevant data table according to an embodiment of the present invention;

FIG. 5 shows a schematic flow diagram of a method for reusing a query block according to an embodiment of the present invention;

FIG. 6 shows a schematic block diagram of a system for query according to an embodiment of the present invention; and

FIG. 7 shows a schematic block diagram of a system for reusing a query block according to an embodiment of the present invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure.

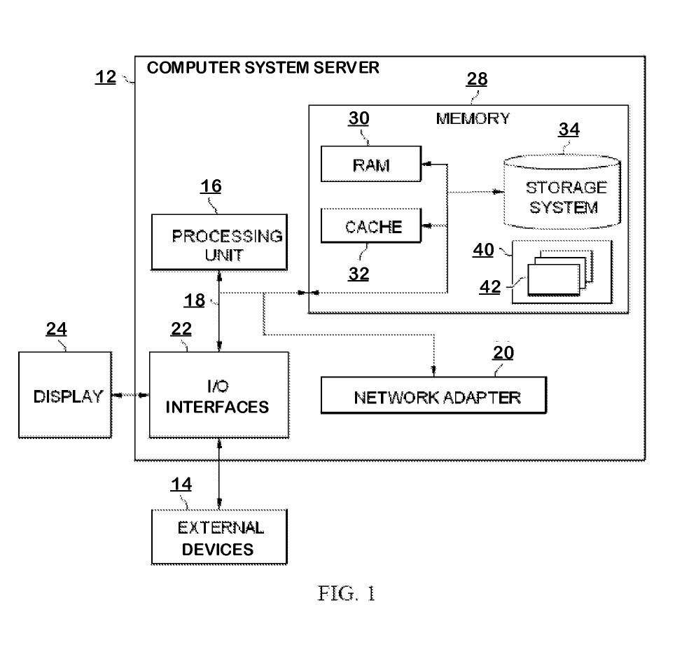

Referring now to FIG. 1, an exemplary computer system/server 12 which is applicable to implement embodiments of the present invention is shown. The computer system/server 12 is illustrative and is not intended to suggest any limitation as to the scope of use or functionality of embodiments of the invention described herein. As shown in FIG. 1, the computer system/server 12 is shown in the form of a general-purpose computing device. The components of the computer system/server 12 may include, but are not limited to, one or more processors or processing units 16, a system memory 28, and a bus 18 that couples various system components including a system memory 28 to a processor 16.

The bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computer system/server 12 typically includes a variety of computer system readable media. Such media may be any available media that is accessible by computer system/server 12, and it includes both volatile and non-volatile media, removable and non-removable media.

The system memory 28 can include computer system readable media in the form of volatile memory, such as random access memory (RAM) 30 and/or cache memory 32. The computer system/server 12 may further include other removable/non-removable, volatile/non-volatile computer system storage media. For example, a storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, the memory 28 may include at least one program product having a set (e.g., at least one) of program modules that are configured to carry out the functions of embodiments of the invention.

A program/utility 40, having a set (at least one) of program modules 42, may be stored in the memory 28 by way of example, and not limited to, an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

The computer system/server 12 may also communicate with one or more external devices 14 such as a keyboard, a pointing device, a display 24, etc.; one or more devices that enable a user to interact with the computer system/server 12; and/or any devices (e.g., network card, modem, etc.) that enable the computer system/server 12 to communicate with one or more other computing devices. Such communication can occur via Input/Output (I/O) interfaces 22. Still yet, the computer system/server 12 can communicate with one or more networks such as a local area network (LAN), a general wide area network (WAN), and/or a public network (e.g., the Internet) via a network adapter 20. As depicted, the network adapter 20 communicates with the other components of the computer system/server 12 via the bus 18. It should be understood that although not shown, other hardware and/or software components could be used in conjunction with the computer system/server 12. Further examples may include, but are not limited to: microcode, device drivers, redundant processing units, external disk drive arrays, RAID systems, tape drives, and data archival storage systems, etc.

Hereinafter, the mechanism and principle of embodiments of the present invention will be described in detail. Unless otherwise stated, the term “based on” used hereinafter and in the claims expresses “at least partially based on.” The term “comprise” or “include” or a similar expression indicates an open inclusion, i.e., “including, but not limited to . . . . ” The term “plural” or a similar expression indicates “two or more.” The term “one embodiment” indicates “at least one embodiment.” The term “another embodiment” indicates “at least one further embodiment.” Definitions of other terms will be provided in the description infra.

As indicated above, a query for a database may contain a query block. The term “query block”, as used here, may include a portion having relatively independent semantics involving one or more tables in a query. For example, a query block may generally be used with a “FROM” statement. An example of the query block is a view. For the purpose of illustration, the following query statement compiled using a structured query language (SQL) creates a view named “View 1” based on data tables T1 and T2 in a database:

Create Table View1
(Select T1.C1 as C1, Sum(T1.C2) C2
From Base_Table1 T1,
Base_Table2 T2
Where T2.C3 > 3000
And T1.C4=T2.C4
Group by T1.C1);

In this example, the created view “View1” includes two columns, C1 and C2, whose data are selected from the data table T1, while the select condition is indicated by a “Where” statement. The query statement from “Select” to “Group” forms a query block.

Another example of the query block is a nested data tab expression, which is usually used for designating a sub-query, for example.

```
Select C1
From View1 V1
Where V1.C2 IN
  (Select T1.C1 as C1
  From Base_Table1 T1,
    Base_Table2 T2
    Where T2.C3 > 3000
        And T1.C4=T2.C4
      Group by T1.C1);
```

In this example, the query statement from “Select” to “Group” in the parentheses defines a sub-query, which may also be regarded as a query block. Other examples of a query block, includes, but are not limited to, one or more of the following: UNION, UNION ALL, EXCEPT, INTERSECT, and the like.

As mentioned above, the query block may be materialized. A result set of the query block may be physically stored in a work file. For example, in the example described above, the data involved in the view “View” are read from the data table T1 and stored in the work file. Then, a query regarding “View1” may be performed based on a result set in the work file. In a traditional database, the work file will be released after the query is completed. For example, it is assumed that the user inputs the following query for “View1”:

Select C1
From View1 V1
Where V1.C2<5000

The query will be performed based on the result set stored in the work file of “View1”. After the query is completed, the work file is released.

It is assumed that the user inputs a different query for the same “View1”, for example:

Select C1
From View1 V1
Where V1.C2>6000

In order to execute this new query, the database system has to create a work file for the “View1” once again and release the work file again after the query is completed. This duplication of effort prolongs the query response time and increases system overheads.

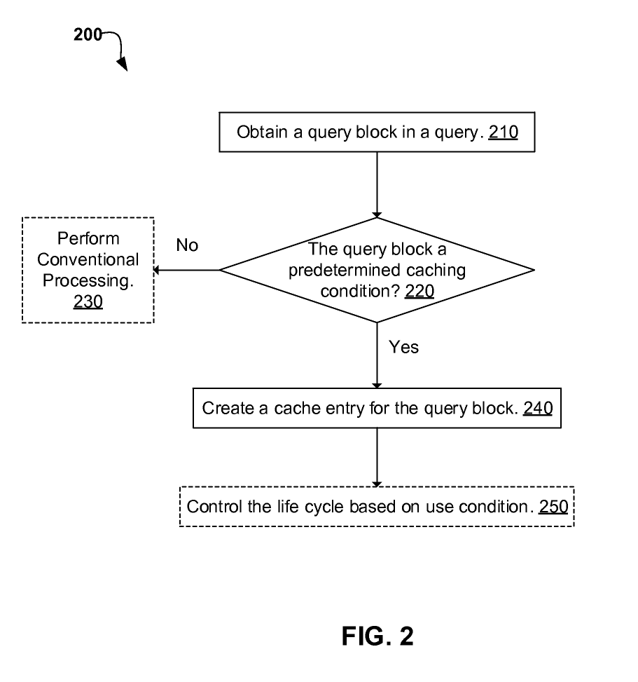

In order to solve the above problem, according to embodiments of the present invention, instead of only caching the result of the query block, the query block in the query may be cached. FIG. 2 shows a flow diagram of a method 200 for query according to an embodiment of the present invention.

The method 200 is entered at step 210, in which a query block included in a query for a database is obtained. In one embodiment, the query processed in step 210 is a true query inputted by a user into the database. In other words, in such an embodiment, during actual use of the database, a query block included in the query inputted by the user may be cached in real-time, called “online caching”.

In such an embodiment, it may be first identified whether a received query includes a query block. For example, in one embodiment, predefined keywords such as “SELECT,” “FROM,” “UNION,” “UNION ALL,” “EXCEPT,” and “INTERSECT” may be searched in a query statement, to determine whether the query includes a query block such as a view, a sub-query, etc. If the query does not include a query block, the query may be performed in a conventional manner. Otherwise, if the query includes a query block, a statement defining a query block may be extracted in step 210, for subsequent processing.

For example, when the query statement includes keywords such as “SELECT,” “FROM,” it may be further determined whether the query involves previously created one or more views, for example, “View1” as described in the above example. In one embodiment, a name of an already created view may be searched in the query. The name of the created view and other information may be maintained by a database management system. If the query includes previously created one or more views, it may be regarded that the query comprises query blocks. Similarly, if statements such as “SELECT” and/or “FROM” include nested “SELECT” and/or “FROM” statements, it may be determined that the query contains a query block.

For another example, in the case that the query includes keywords such as “UNION,” “UNION ALL,” “EXCEPT,” “INTERSECT” and the like, it may be determined that the objects involved by these statements are simple objects or embedded statements. Where they are query statements, including nests, it may be regarded that the current query comprises query blocks. As an example, the two objects involved in the following “UNION ALL” statement are both nested queries defined by “Select” statements. Therefore, the query may be determined to include query blocks.

```
(Select T1.C1 as C1
  From Base_Table1 T1,
    Base_Table2 T2
    Where T2.C3 > 3000
    And T1.C4 = T2.C4
    Group by T1.C1)
UNION ALL
(Select T3.C1 as C1
  From Base_Table3 T3,
  Base_Table4 T4
  Where T3.C3 > 3000
    And T3.C4=T4.C4
  Group by T1.C1);
```

According to embodiments of the present invention, if the query does not comprise query blocks, the query may be processed according to a conventional manner. Otherwise, if the query comprises query blocks, the statements defining the query blocks may be extracted in step 210 for subsequent processing.

Alternatively or additionally, in one embodiment, the query processed in step 210 may also be a sample query as training data. For example, a known query including a typical or common query block may be selected as a sample, so as to reuse such query blocks in subsequent query processing. In other words, besides the online caching, embodiments of the present invention may also allow caching a pre-prepared sample query block before the database is put into use, which is called “offline caching”.

Next, the method 200 proceeds to step 220, in which it is determined whether the query block obtained in step 210 satisfies a predetermined caching condition. For example, in one embodiment, the caching condition may involve a computation cost required for generating a result set of the query block. As an example, the computation cost may include processor executing time, input/ output (I/O) time, etc. It is advantageous to consider the computation cost for generating the result set, because the computation cost for creating a cache entry may mainly come from the computation cost required for generating the result set.

In such an embodiment, when the computation cost of generating a result set is greater than a predetermined threshold cost, can the caching condition be satisfied. In other words, for a query block, if the computation cost required for generating the result set of the query block is small enough, real-time materializing the query block may not bring too much burden to the query performance. Therefore, such query block may not be cached; instead, it may be materialized when necessary, like in the traditional solution. Otherwise, if the computation cost for materializing the query block is relatively high, caching such a query block will help enhance the query performance.

Alternatively or additionally, in one embodiment, the caching condition may involve storage cost needed to store the result set of the query block. It is advantageous to account for the storage cost for storing the result set, because the storage cost of the cache entry mainly comes from the storage cost required for storing the result set. Specifically, in such an embodiment, when the amount of storage resources required for storing the result set is lower than a predetermined threshold amount, the query block may be cached. Such practice is advantageous, for example, it may avoid occupying too many storage resources.

According to embodiments of the present invention, the above caching conditions may be used individually or in combination. For example, in one embodiment, for any given query block, a ratio between the computation cost required for calculating the result set and the storage cost required for storing the result set may be determined. The caching condition may require that the radio exceed the predetermined threshold. In other words, when the computation cost of the result set is large enough while the storage resources occupied are small enough, may the query block be cached. In this way, a balance between the computation cost and the storage cost may be achieved.

Particularly, in one embodiment, the caching condition may be “empty”. In this embodiment, the query block obtained in step 210 will satisfy the caching conditions. In other words, in such an embodiment, the query block contained in the query may be directly cached, without decision operation concerning the caching condition. At this point, step 220 of the method 200, in fact, may be omitted.

If it is determined in step 220 that the caching condition is not satisfied (branch “No”), for the online caching, the method 200 may proceed to step 230, in which the query is processed in a conventional manner. It should be noted that step 230 is optional (shown in dotted line in the FIG. 2), because for the offline caching, the method 200 may end now.

Otherwise, if it is determined in step 220 that the query block satisfies the caching condition (branch “Yes”), the method proceeds to step 240, in which a cache entry for the current query block may be created in a query cache. As used herein, the term “query cache” refers to storage medium for storing query entries. In one embodiment, the query cache may, but not necessarily, be implemented using high-speed storage medium like flash memory. In another embodiment, it is possible to use volatile or non-volatile mediums with lower speed such as memory, disk or tape to function as the query cache. The scope of the invention is not limited in this regard.

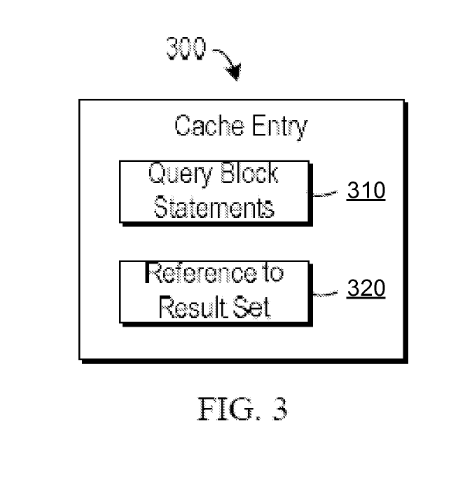

According to one embodiment, a cache entry for a query block may at least indicate a statement and a result set for the query block. FIG. 3 shows a schematic diagram of a cache entry 300 according to one embodiment of the present invention. As shown in FIG. 3, the cache entry 300 may indicate a statement 310 of the query block. For example, in one embodiment, a text forming a SQL statement of the query block may be stored in the cache entry.

Besides, the cache entry 300 may have a reference 320 for the result set. For example, in one embodiment, the reference 320 for the result set may be implemented as a pointer pointing to a work file storing the result set of the query block. Alternatively, in one embodiment, the reference 320 for the result set may be the result set. In other words, in such an embodiment, the result set may be directly stored in the cache entry 300.

In particular, it should be understood that according to embodiments of the present invention, the result set of the cached query block will not be deleted with the completion of the query. Instead, after the query is completed, the result set (e.g., the work file) and the entire cache entry for the query block may be maintained at least for a time period. In this way, the result set for the query block may be reused in subsequent query processing.

It should be understood that the query block may involve one or more data tables. These data tables may be called “base tables” of the query block. For example, in the above described example, data tables T1 and T2 are base tables of the query block for creating “View1”. In one embodiment, in step 240, the cache entry of the query block is created in association with the base table. In other words, an association between the cache entry and the base table of the query block can be created.

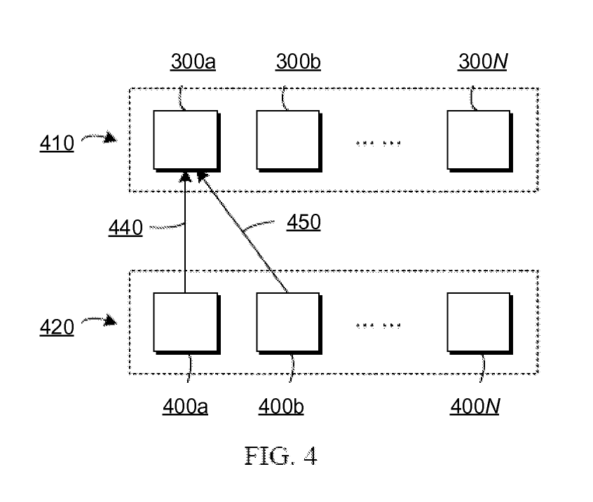

FIG. 4 shows a schematic diagram of an association between a cache entry and a base table according to one embodiment of the present invention. In the example of FIG. 4, the query cache 410 may comprise one or more cache entries 300a, 300b . . . 300N, wherein N is a natural number. As mentioned above, each cache entry 300 indicates a statement and a result set of a corresponding query block. Meanwhile, a list 420 of base tables may be maintained. Each entry 430a, 430b . . . 430N in the list of base tables 420 indicates a data table that acts as a base table for the cached at least one query block.

In the example shown in FIG. 4, the association between a data table and a cache entry may be implemented by a pointer or a similar data structure. Specifically, each entry 430 in the list 420 of base stations may have one or more pointers each pointing to a cache entry 300 of the query block with a corresponding data table as the base table. In this way, each data table may be associated with all cache entries 300 of the query block related to the data table.

As an example, still consider the example of view “View1” as described above. Suppose the entry 430a in the list 420 of the base tables indicates the data table T1, entry 430b indicates the data table T2, and the cache entry 300a is a cache entry of the query block for creating the view “View1”. In step 240, when the cache entry 300a is generated in the query cache 410, entries 430a and 430b representing T1 and T2, respectively, are created in the list 410 of the base tables. Moreover, pointers 440 and 450 pointing to the cache entry 300a from the entries 430a and 430b may be generated, respectively. In this way, base tables T1 and T2 are associated with the cache entries of the corresponding query block.

It is advantageous to create an association between a cache entry and a data table. It would be understood that when the data table changes, the result set of the query block involving the data table always also changes. Change of the data table may include: update, deletion, insertion, and the like of the data table. Based on the association between data tables and cache entries, when a data table acting as a base stable changes, a cache entry of the relevant query block can be effectively maintained, thereby guaranteeing the consistency and correctness of the data.

For example, in one embodiment, when a data table is updated or has a new entry inserted, a result set for the query block may be re-generated based on the changed data table, and the work file for the query block is updated. Alternatively, after any change to the data table, cache entries of all query blocks related to the data table may be deleted. In this case, work files for these query blocks may also be released correspondingly.

Continue referring to FIG. 2. The method 200 proceeds to step 250, where a lift cycle of the cache entry, namely, the length of the time period in which the cache entry will be maintained, is controlled based on usage of the cache entry. In such an embodiment, each cache entry may have a life cycle of a predetermined length. When the life cycle of a cache entry expires, the cache entry is removed from the query cache. The corresponding work file may also be released. For example, in one embodiment, each cache entry may be associated with one timer. This timer sustains at least the life cycle of a cache time. When the timer is due, removal of the corresponding cache entry from the query cache will be triggered.

In such an embodiment, each time when a cache entry of a query block is used once, the life cycle of the cache entry may be prolonged for a certain time period. This may be realized by, for example, resetting associated timer after usage of the cache entry. In this way, it may be guaranteed that the frequently used cache entry is maintained a longer time in the query cache, while those cache entries rarely used are removed as early as possible.

Alternatively or additionally, the life cycle may also be controlled based on use of the cache item through other manners. For example, when the storage resource allocated to the query cache reaches the upper limit, it is needed to release one or more query entries in the query cache. In this case, based on use of each cache entry, any currently known or future developed cache management mechanisms, such as least recently used (LRU), least frequently used (LFU), may be used, thereby selecting those cache entries to be deleted.

It should be understood that step 250 is not a must (shown in dotted lines in the figure). For example, in some embodiments, the life cycle of a cache entry may be controlled based on other factors. For example, the query cache may be managed simply based on the size of the storage resource allocated to the query cache and the creation time of each cache entry. As an example, when the storage resources of the query cache reach the upper limit, one or more cache entries created earlier may be removed according to a first-in first-out policy. In actuality, any currently known or future developed cache management policy may be used in combination with embodiments of the present invention.

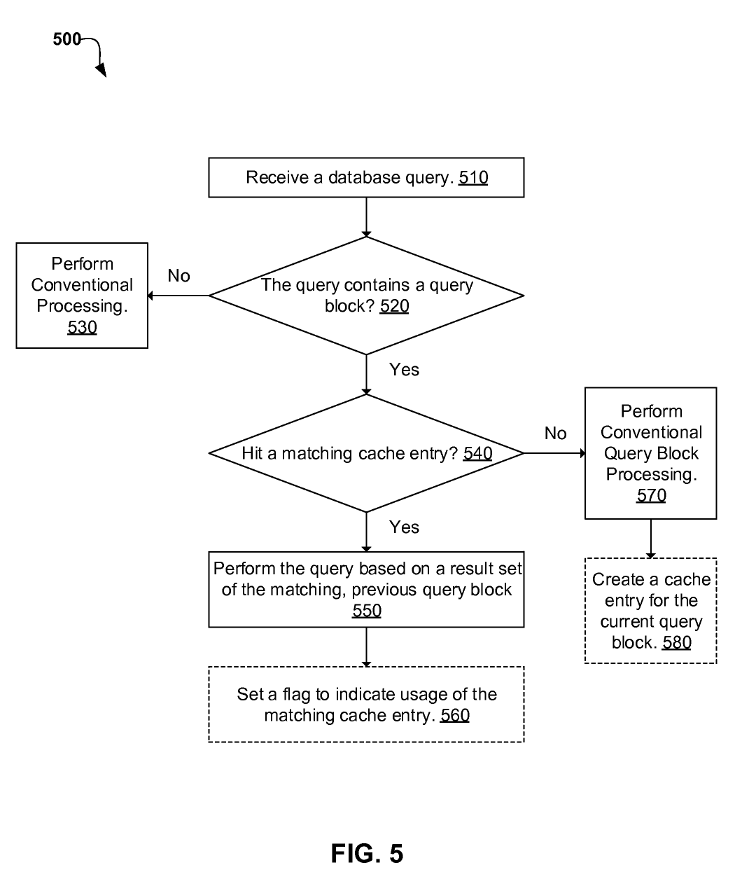

Referring to FIG. 5, a schematic flow diagram of a method 500 for reusing a query block according to an embodiment of the present invention is presented. The method 500 starts from step S510, in which a query for a database is received.

Next, in step 520, it is determined whether a received database query includes a query block. As mentioned above, in one embodiment, by searching keywords such as “SELECT,” “FROM,” “UNION,” “UNION ALL,” “EXCEPT,” “INTERSECT” in the query state, it is determined whether the query includes a query block such as a view, a sub-query, etc.

If it is determined in step 520 that the query does not include a sub-query block (branch “NO”), the method 500 proceeds to step 530, in which the query is processed in a conventional manner. On the contrary, if it is determined in step 520 that the query includes a query block (branch “Yes”), the method 500 proceeds to step 540, in which a matching cache entry is searched in the query cache based on the statement of the query block. The term “matching cache entry” used here refers to the cache entry of a previous query block that matches the query block received in step 510. As mentioned above, the matching cache entry may indicate the query statement and the result set of the matching previous query block.

According to embodiments of the present invention, the previous query block matching the received current query block may be determined through various appropriate manners. For example, it may be based on text match between query statements to determine whether two query blocks are matched. As mentioned above, each cache entry 300 in the query cache may indicate a statement 310 of a corresponding previous query block. In this way, the statement of the cached previous query block may be obtained and matched, in terms of text, to the statement of the received current query block.

In one embodiment, when the texts of the statements of two query blocks are completely identical, the two query blocks are determined to match each other. By virtue of such text matching technology, a matching previous query block can be found efficiently. Alternatively, a query statement of a query block may be normalized before matching. In one embodiment, the normalization may be performed based on a predetermined rule. For example, characters such as blank, new lie in the text may be removed; case of letters may be uniformed, etc. by removing these “noises” in the text of the statement, it may be avoided to miss-detect a previous query block matching the current query block.

Alternatively or additionally, in one embodiment, the statement of the received query block may be parsed in step 540 to obtain a syntax tree of the query block. In one embodiment, a query statement may be parsed by an optimizer of the database system. As already known, the syntax tree is a tree structure used to represent the relational algebra expression of the query. The tree structure may be generated by grammatical analysis on the relational algebra expression of the query. In the syntax tree, leaf nodes represent relations, while non-leaf odes represent operations. In a similar manner, the syntax tree of any cached previous query block may also be obtained. In this way, the matching previous query block may be searched by comparing the syntax tree of the current query block and the syntax trees of one or more previous query blocks.

According to embodiments of the present invention, text match and syntax tree match may be used individually or in combination. For example, texts of statements of the query blocks may be matched first. If a matching previous query block is not found through text match, the syntax tree match may be turned to. It may be understood that generally, the computation cost and efficiency of text match are superior to the syntax tree match; while the accuracy of syntax tree match is superior to the pure text match. Through such two-stage matches, a good balance may be achieved between match efficiency and accuracy.

In response to hitting the matching cache entry (branch “YES”) in step 540, the method 500 proceeds to step 550, in which the received query is performed based on a result set of the matching previous query block. As mentioned above, the matching cache entry 300 has a reference 320 relative to the result set of the matching previous query block. For example, the reference 320 relative to the result set may be implemented as pointer pointing to the work file of the previous query block. In this way, in step 550, the result set of the matching previous query block may be located and accessed based on the reference 320. Next, query may be directly performed on the result set. As an example, in the case that the result set of “View1” is cached, any query regarding View1 may be directly performed on the result set of the cached View1. In this way, the execution efficiency of the query block can be significantly enhanced.

The method 500 then proceeds to step 560, in which a flag is set to indicate usage of the matching cache entry. As mentioned above, in one embodiment, each cache entry may be associated with one timer that indicates a life cycle of the cache entry. After use of the matching cache entry, the timer associated with the matching cache entry may be reset in step 560. As mentioned above, in this way, the life cycle of the matching cache entry may be prolonged. Alternatively or additionally, any appropriate flag bit may be set to indicate usage of the matching cache entry.

It should be understood that, similar to step 250 of method 200, step 560 is not a must (shown in dotted lines in FIG. 5). In some embodiments, the life cycle of the cache entry may be managed based on other factors besides the use condition.

Return to step 540, if the matching cache entry (branch “NO”) has not been found, the method 500 may proceed to step 570, in which the query for the query block is processed in a conventional manner. For example, at this time, a work file needs to be created for storing the result set of the query block, thereby realizing materialization of the query block.

In particular, in one embodiment, a cache entry of the current query block is created in step 580. For example, in step 580, online cache of the query block may be realized. It should be noted that step 580 is optional, and thus shown in dotted lines in FIG. 5. For example, in one embodiment, the user may explicitly disables online caching of query blocks. In this case, a cache entry for the received query will not be created. For another example, when the storage resources allocated to the query cache reach the upper limit, online caching of the query blocks may be suspended. In these cases, step 580 may be omitted.

By caching and reusing one or more query blocks included in a query, performance of the query processing, including the processor performance and I/O performance, can be significantly improved. Additionally, less data table access can also reduce contention and conflict with respect to the database objects. Moreover, the query response time will be shortened, thereby improving user experience.

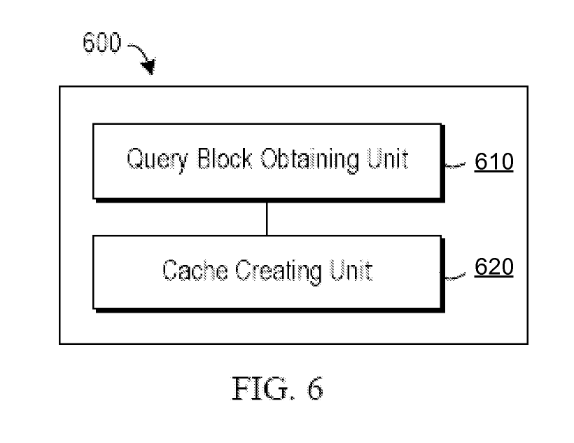

FIG. 6 shows a schematic block diagram of a system 600 for query according to an embodiment of the present invention. As shown, the system 600 comprises: a query block obtaining unit 610 configured to obtain a query block contained in a query for a database; and a cache creating unit 620 configured to, in response to the query block satisfying the predetermined caching condition, create a cache entry for the query block, whereby the cache entry indicates a statement and a result set for the query block, and wherein the cache entry will be maintained for a time period after the query is completed.

In one embodiment, the predetermined caching condition is associated with at least one of the following: computation cost required for generating the result set of the query block; and storage cost for storing the result set of the query block

In one embodiment, the query block is associated with at least one data table in the database. In this case, the cache creating unit 620 may comprise: an association generating unit configured to generate an association between the cache entry and the at least one data table. In one embodiment, the system 600 may further comprise: a cache maintaining unit configured to maintain the cache entry in response to change of the at least one data table.

In one embodiment, the system 600 may further comprise: a life cycle control unit configured to control a life cycle of the cache entry based on usage of the cache entry.

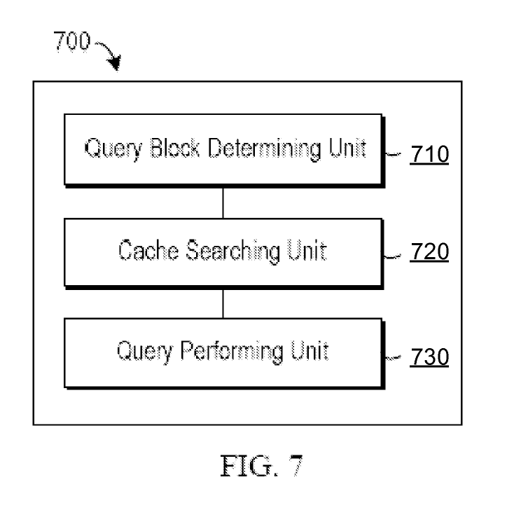

FIG. 7 shows a schematic block diagram of a system for reusing a query block according to an embodiment of the present invention. As shown in the figure, the system 700 comprises: a query block determining unit 710 configured to determine whether a query for the database has contained a query block; a cache searching unit 720 configured to, in response to the query containing the query block, search for a matching cache entry based on a statement of the query block, whereby the matching cache entry indicates a statement and a result set of a previous query block matching the query block; and a query performing unit 730 configured to, in response to hitting the matching cache entry, perform the query by reusing the result set of the previous query block.

In one embodiment, the cache searching unit 720 may comprise: a text searching unit configured to search the matching cache entry based on a text of the statement of the query block. Alternatively or additionally, in one embodiment, the cache searching unit 720 may comprise: a first parsing unit configured to parse the statement of the query block to generate a syntax tree of the query block; a second parsing unit configured to parse parsing a previous query block indicated by a cache entry in the query cache to generate a syntax tree of the previous query block; and a syntax tree comparing unit configured to compare the syntax tree of the query block and the syntax tree of the previous query block to search for the matching cache entry.

In one embodiment, the system 700 may further comprise: a use setting unit configured to set a flag to indicate usage of the matching cache entry so as to control a life cycle of the matching cache entry.

In one embodiment, the system 700 may further comprise: a caching unit configured to, in response to missing the matching cache entry, cache the query block contained in the query by enabling the system 600 discussed above with reference to FIG. 6.

It should be noted that for the sake of clarity, FIGS. 6 and 7 do not show optional units or sub-units included in the systems 600 and 700. The features and operations as described above are suitable for systems 600 and 700, respectively, which are therefore not detailed here. Moreover, partitioning of units or subunits in systems 600 and 700 is exemplary, rather than limitative, intended to describe its main functions or operations logically. A function of one unit may be implemented by a plurality of other units; on the contrary, a plurality of units may be implemented by one unit. The scope of the present invention is not limited in this aspect.

Moreover, the units included in the systems 600 and 700 may be implemented by various manners, including software, hardware, firmware or a random combination thereof. For example, in some embodiments, the apparatus may be implemented by software and/or firmware. Alternatively or additionally, the systems 600 and 700 may be implemented partially or completely based on hardware. For example, one or more units in the systems 600 and 700 may be implemented as an integrated circuit (IC) chip, an application-specific integrated circuit (ASIC), a system on chip (SOC), a field programmable gate array (FPGA), etc. The scope of the present intention is not limited to this aspect.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
obtaining a query block contained in a query for a database; and
in response to the query block satisfying a predetermined caching condition, creating a cache entry for the query block, wherein the cache entry indicates a plurality of statements and a result set for the query block, and wherein the cache entry is maintained after the query is completed.

2. The method of claim 1, wherein the predetermined caching condition is associated with at least one of a computation cost for generating the result set of the query block, and a storage cost for storing the result set of the query block.

3. The method of claim 1, wherein the query block includes at least one data table in the database, and wherein creating a cache entry for the query block further comprises:
generating an association between the cache entry and the at least one data table.

4. The method of claim 3, further comprising:
in response to a change in the at least one data table, maintaining the cache entry based on the association between the cache entry and the at least one data table.

5. The method of claim 1, further comprising:
controlling, based on usage of the cache entry, a length of time the cache entry is maintained.

6. A method, comprising:
determining whether a query for the database contains a query block;
in response to the query containing the query block, searching for a matching cache entry based on a plurality of statements of the query block, wherein the matching cache entry indicates that a plurality of statements and a result set associated with a previous query block matches the query block; and
in response to identifying the matching cache entry, performing the query by reusing the result set of the previous query block.

7. The method of claim 6, wherein searching for a matching cache entry based on a plurality of statements associated with the query block further comprises:
searching for the matching cache entry based on a plurality of texts associated with the plurality of statements of the query block.

8. The method of claim 6, wherein searching for a matching cache entry based on the plurality of statements of the query block further comprises:
parsing the statements of the query block to generate a syntax tree of the query block;
parsing a previous query block indicated by a stored cache entry to generate a syntax tree of the previous query block; and
searching for the matching cache entry by comparing the syntax tree of the query block and the syntax tree of the previous query block.

9. The method of claim 6, further comprising:
setting a flag to indicate usage of the matching cache entry to control a length of time the matching cache entry is maintained.

10. The method of claim 6, further comprising:
in response to missing the matching cache entry, caching the query block contained in the query.

11. A system, comprising:
a query block obtaining unit configured to obtain a query block contained in a query for a database;
a cache creating unit configured to, in response to the query block satisfying the predetermined caching condition, create a cache entry for the query block, whereby the cache entry indicates a plurality of statements and a result set for the query block, and wherein the cache entry is maintained after the query is completed;
a query block determining unit configured to determine whether a query for the database contains a query block;
a cache searching unit configured to, in response to the query containing the query block, search for a matching cache entry based on a plurality of statements of the query block, wherein the matching cache entry indicates that a plurality of statements and a result set associated with a previous query block matches the query block; and
a query performing unit configured to, in response to identifying the matching cache entry, perform the query by reusing the result set of the previous query block.

12. The system of claim 11, wherein the predetermined caching condition is associated with at least one of a computation cost for generating the result set of the query block, and a storage cost for storing the result set of the query block.

13. The system of claim 11, wherein the query block includes at least one data table in the database, and wherein the cache creating unit further comprises:
an association generating unit configured to generate an association between the cache entry and the at least one data table.

14. The system of claim 13, further comprising:
a cache maintaining unit configured to, in response to a change in the at least one data table, maintain the cache entry based on the generated association between the cache entry and the at least one data table.

15. The system of claim 11, further comprising:
a life cycle controlling unit configured to control, based on usage of the cache entry, a length of time the cache entry is maintained;
a usage setting unit configured to set a flag to indicate usage of the matching cache entry to control a length of time the matching cache entry is maintained; and
a caching unit configured to, in response to missing the matching cache entry, cache the query block contained in the query.

16. The system of claim 11, wherein the cache searching unit further comprises:
a text searching unit configured to search for the matching cache entry based on a plurality of texts associated with the plurality of statements of the query block;
a first parsing unit configured to parse the statements of the query block to generate a syntax tree of the query block;
a second parsing unit configured to parse a previous query block indicated by a stored cache entry to generate a syntax tree of the previous query block; and
a syntax tree comparing unit configured to compare the syntax tree of the query block and the syntax tree of the previous query block to search for the matching cache entry.
